(19) United States
(12) Patent Application Publication
(10) Pub. No.: US 2004/0255794 A1
(43) Pub. Date: Dec. 23, 2004

(54) Current-carrying/heating apparatus of liquid food

(75) Inventors: Hiroshi Hoshino, Bunkyo-ku (JP); Akihiro Maruta, Bunkyo-ku (JP)

Correspondence Address: McCormick, Paulding & Huber, LLP, 185 Asylum Street, CityPlace II, Hartford, CT, 06103-3402, US

(73) Assignee: Frontier Engineering Co., Ltd, Bunkyo-ku (JP)

(21) Appl. No.: 10/774,961

(22) Filed: Feb. 9, 2004

(30) Foreign Application Priority Data
Jun. 19, 2003 (JP) 2003-174608

(51) Int. Cl. A23L 3/26

(52) U.S. Cl. 99/451

(57) ABSTRACT

Fluid heat-exposed food can be uniformly heated with high energy efficiency. A current-carrying/heating apparatus is applied to use fluid meat and drink, such as soup or the like, as the heat-exposed food and to heat it by resistance heat. A primary winding is winded about an iron core and is connected to an AC power supply. A heat pipe is further winded about the iron core. A communication hole, into which the meat and drink used as the heat-exposed food is supplied, is formed in the heat pipe. An electric closed loop circuit is constituted by the heat-exposed food supplied into the communication hole. When a current is carried to the primary winding, a magnetic flux is generated around the iron core by the current. A current, induced by an operation of electromagnetic induction of the magnetic flux, flows to the heat-exposed food, and the heat-exposed food generates heat by the induced current and is heated.

### BACKGROUND OF THE INVENTION

The present invention relates to a current-carrying/heating apparatus of liquid food, in which fluid meat and drink, such as juice, soup or the like, is mainly used as heat-exposed food and the heat-exposed food is heated by resistance heat created by a current flowing to the heat-exposed food.

There is performed a heat treatment of liquid meat and drink such as juice, soup or the like, or of fluid meat and drink, which is liquid or half solid food containing solid substances such as vegetables and/or pieces of meat or the like similarly to stew or the like, in cooking and/or sterilizing the meat and drink. To heat such fluid meat and drink, as disclosed in patent document 1, a current-carrying/heating apparatus, which has transport pipes formed by disposing alternately insulating cylinders and ring electrodes, has been developed, and the meat and drink is continuously heated by supplying it to the transport pipes.

Patent document 1: Japanese Patent Publication No. 2793473.

### SUMMARY OF THE INVENTION

In the conventional current-carrying/heating apparatus in which electric power is supplied to the paired ring electrodes and the current is carried to the meat and drink flowing into the cylinders between the ring electrodes and the meat and drink is heated by its resistance heat, an inside edge of the ring electrode has a higher current density than an inner circumferential surface thereof. Therefore, a peripheral portion of a flow path in the transport pipe is higher in a current density than a central portion thereof. This causes variation in heat temperatures of the meat and drink flowing into the transport pipe to occur depending on radial positions, and therefore the entire of the radial positions cannot be heated uniformly. Since a high-frequency current is supplied to the electrodes, the conventional current-carrying/heating apparatus is provided with a converter for converting a power-frequency current to a high-frequency current and the high-frequency current is supplied the electrodes through cables linking the converter and the electrodes. However, since the high-frequency current has larger electric transmission losses than a low-frequency current, energy losses are increased when the high-frequency current is supplied to the electrodes.

An object of the present invention is to provide a current-carrying/heating apparatus of liquid food, in which the heat-exposed food can be heated wholly and uniformly.

Another object of the present invention is to provide a current-carrying/heating apparatus of liquid food, in which the heat-exposed food can be heated with high energy efficiency.

According to the present invention, a current-carrying/heating apparatus of liquid food, which carries a current to fluid heat-exposed food and heats the heat-exposed food by resistance heat obtained, comprises: a primary winding winded about an iron core and connected to an AC power supply; and a heat pipe winded about said iron core, having a communication hole to which the heat-exposed food is supplied, and constituting an electric closed loop circuit through the heat-exposed food supplied to said communication hole, wherein a electromagnetic flux is generated around said iron core by the current flowing to said primary winding, and a current, induced by an operation of electromagnetic induction of the magnetic flux, flows to the heat-exposed food.

According to the present invention, a current-carrying/heating apparatus of liquid food, which carries a current to fluid heat-exposed food and heats the heat-exposed food by resistance heat obtained, comprises: a primary winding winded about an iron core and connected to an AC power supply; a heat pipe winded about said iron core and having a communication hole to which the heat-exposed food is supplied; and a conductive partition member provided in said heat pipe, physically closing said communication hole, and constituting an electric closed loop circuit along with the heat-exposed food supplied into said communication hole, wherein a magnetic flux is generated around said iron core by the current flowing to said primary winding, and a current, induced by an operation of electromagnetic induction of the magnetic flux, flows to the heat-exposed food through said partition member.

According to the present invention, a current-carrying/heating apparatus of liquid food, which carries a current to fluid heat-exposed food and heats the heat-exposed food by resistance heat obtained, comprises: a primary winding winded about an iron core and connected to an AC power supply; a heat pipe winded about said iron core and having a communication hole to which the heat-exposed food is supplied; an insulating partition member provided in said heat pipe and physically closing said communication hole; and a secondary winding winded about said iron core, having a terminal provided so as to be exposed to said communication hole on both sides of said partition member, and constituting an electric closed loop circuit along with the heat-exposed food supplied into said communication hole, wherein a magnetic flux is generated around said iron core by the current flowing to said primary winding, and a current, induced by an operation of electromagnetic induction of the magnetic flux, flows to the heat-exposed food through said secondary winding.

In a current-carrying/heating apparatus of liquid food according to the present invention, said heat pipe includes: a supply portion in which a supply hole communicating with said communication hole is provided and which supplies the heat-exposed food into said communication hole; and an exhaust portion in which an exhaust hole communicating with said communication hole is provided and which exhausts the heat-exposed food from said communication hole, and the heat-exposed food is heated while continuously flowing into said communication hole. Further, said heat pipe includes a plurality of winding parts, which are winded about said iron core and continue helically.

In a current-carrying/heating apparatus of liquid food according to the present invention, the conductive heat-exposed food is supplied to the communication hole of the heat pipe winded about the iron core, and the electric closed loop circuit is constituted in the heat pipe by the supplied heat-exposed food. Therefore, the magnetic flux is generated around the iron core by the current flowing to the primary winding, and a current is induced in the heat-exposed food in the electric closed loop circuit by the operation of electromagnetic induction of the magnetic flux. The heat-exposed food generates resistance heat due to the induced current, and is heated to a desired temperature. Thus, the current directly flows to the heat-exposed food by the magnetic flux generated around the iron core and the heat-exposed food is heated, thereby allowing the heat-exposed food in the heat pipe to be uniformly heated and allowing the energy losses to be reduced and the heat-exposed food to be heated with high energy efficiency.

### BRIEF DESCRIPTION OF THE DRAWINGS

FIG. 1 is a partially broken perspective view showing a current-carrying/heating apparatus of liquid food, which is an embodiment of the present invention.

FIG. 2 is a partially broken perspective view showing a current-carrying/heating apparatus of liquid food, which is another embodiment of the present invention.

FIG. 3 is a sectional view showing a heat pipe in the current-carrying/heating apparatus that is another embodiment of the present invention.

FIG. 4 is a partially broken perspective view showing a current-carrying/heating apparatus of liquid food, which is another embodiment of the present invention.

FIG. 5 is a sectional view showing a heat pipe in the current-carrying/heating apparatus that is another embodiment of the present invention.

FIG. 6A is a sectional view partially showing a current-carrying/heating apparatus that is another embodiment of the present invention.

FIG. 6B is a sectional view partially showing a current-carrying/heating apparatus that is another embodiment of the present invention.

FIG. 6C is a sectional view partially showing a current-carrying/heating apparatus that is another embodiment of the present invention.

FIG. 7 is a partially broken perspective view showing a current-carrying/heating apparatus of liquid food, which is another embodiment of the present invention.

FIG. 8 is a sectional view taken along the 8-8 line in FIG. 7.

FIG. 9 is a partially broken perspective view showing a current-carrying/heating apparatus of liquid food, which is another embodiment of the present invention.

FIG. 10 is a partially broken perspective view showing a current-carrying/heating apparatus of liquid food, which is another embodiment of the present invention.

### DESCRIPTION OF THE PREFERRED EMBODIMENTS

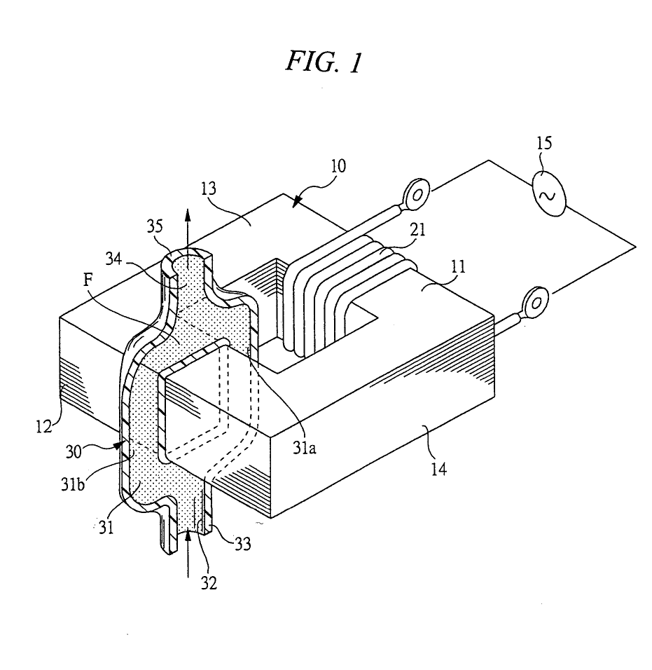

Embodiments of the present invention will be in detail described below based on the drawings. In the drawings showing each embodiment, the same reference numbers denote common members. FIG. 1 is partially broken perspective view showing a current-carrying/heating apparatus of liquid food, which is an embodiment of the present invention. As shown in FIG. 1, the current-carrying/heating apparatus includes an iron core 10. The iron core 10 has four iron-core legs 11 to 14 and is formed into a quadrangle as a whole.

A primary coil comprising a copper wire covered with an insulating coating, i.e., a primary winding 21 is winded about the iron-core leg 11. The primary winding 21 is connected to a power supply unit for applying an alternating current to the primary winding. Accordingly, when the current is applied to the primary winding 21, a magnetic field is generated around the iron core 10, whereby a closed magnetic path is formed in the iron core 10.

An insulating heat pipe 30, made of an insulating material such as a synthetic resin or the like, is winded about the iron core 12. A communication hole 31 for supplying fluid meat and drink such as juice, soup or the like, i.e., supplying heat-exposed food F is formed in the heat pipe 30. The heat pipe 30 is winded one turn about the iron-core leg 12, and the communication hole 31 continues in a loop shape. A supply portion 33, having a supply hole 32 communicating with the communication hole 31, is provided at a lower part of the heat pipe 30. The heat-exposed food F from the supply portion 33 divides into an inside hole 31a and an outside hole 31b and is continuously supplied to the communication hole 31. An exhaust portion 35, having an exhaust hole 34 communicating with the communication hole 31, is provided at an upper part of the heat pipe 35, the upper part being opposite to the supply portion 35. The heat-exposed food F is continuously exhausted from the exhaust portion 35 to the outside.

When the conductive heat-exposed food F is supplied to the communication hole 31 from the supply portion 33 to fill the inside of the communication hole 31 with the heat-exposed food F, an electric closed loop circuit is constituted by the heat-exposed food F in the communication hole 31. Consequently, the current, induced by an operation of electromagnetic induction depending on the magnetic field having been generated around the iron core 10, flows to the heat-exposed food F, and the heat-exposed food F generates heat due to the resistance heat and therefore the heat-exposed food F is heated.

Thus, since the current, induced by the operation of electromagnetic induction, is carried into the heat-exposed food F, it also flows, with the same current density, to any of radial portions of the heat-exposed food F, with which the inside of the communication hole 31 is filled. Therefore, there is reduced the variation in heat temperatures of the heat-exposed food F disposed radically in the communication hole 31. Additionally, the magnetic field is generated around the iron core 10 due to the flow of the current to the primary winding 21 and the current is directly carried to the heat-exposed food F by the generated magnetic field, thereby allowing energy losses to be reduced and allowing the heat-exposed food F to be heated efficiently.

A heat temperature is set depending on: a flow velocity of the heat-exposed food F in the communication hole 31; power applied to the primary winding 21; and the like. The inside hole 31a and the outside hole 31b are respectively set at the same length so that the heat-exposed food F flowing into each of the inside hole 31a and the outside hole 31b has the same heat temperature.

The current-carrying/heating apparatus shown in FIG. 1 continually heats the heat-exposed food F while the heat-exposed food flows into the communication hole 31. However, it may carry the current to the heat-exposed food F, without the flow of the heat-exposed food F into the communication hole 31 and with the communication hole being filled with the heat-exposed food F. In this case, the heat-exposed food F is batch-processed, whereby the supply and exhaust of the heat-exposed food F can be made using one of the supply portion 33 and the exhaust portion 35 shown in FIG. 1.

The power, supplied to the primary winding 21 from the power supply unit 15, can utilize not only a commercial power supply but also a high-frequency power supply with a higher frequency than the commercial power supply or a low-frequency power supply with a lower frequency than it. If the commercial power supply is utilized, a converter for frequency conversion becomes unnecessary and the current-carrying/heating apparatus can be manufactured at lower cost.

The cross-sectional shape of the heat pipe 30 is not limited to the circle as shown in FIG. 1 and may be various cross-sectional shapes such as ellipse, quadrangle, polygon, or the like. The heat pipe 30 is made of a synthetic resin, a rubber, china, or other insulating material. The heat pipe 30 and the iron core 10 are assembled by forming at least one of the heat pipe 30 and the iron core 10 into a divide shape type to manufacture the current-carrying/heating apparatus. For example, if the heat pipe 30 is vertically or horizontally divided into two parts in FIG. 1 and is shaped and the iron core 10 is integrally formed, the heat pipe 30 is fixed to the iron core 10. If the heat pipe 30 is integrally formed and the iron core 10 is divided into some parts and is formed, the part-divided iron core 10 is fixed to the heat-exposed pipe 30.

The entire of the heat pipe 30 can be made, as described above, of an insulating material and further may have a structure of combining an insulating plate made of a insulative material and a metallic or semi-conductive reinforcing plate. In this case, the structure of substantially getting the heat pipe 30 having an insulating property requires that most of the current flows to the electric closed loop circuit constituted by the heat-exposed food.

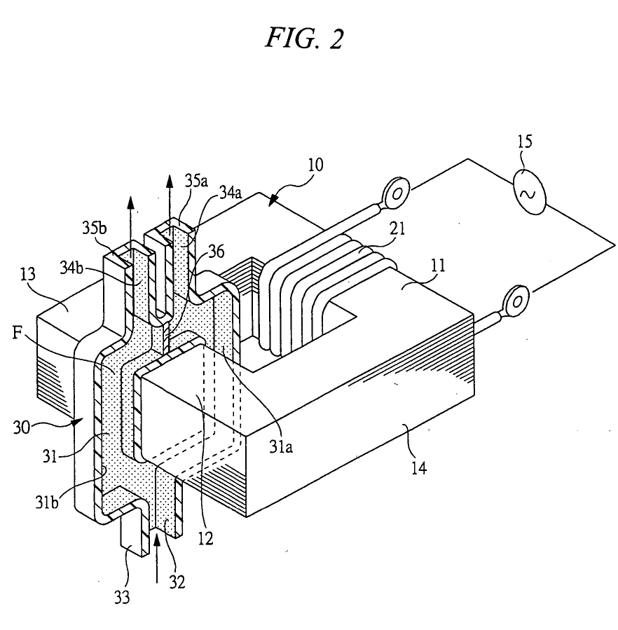

FIG. 2 is a partially broken perspective view showing a current-carrying/heating apparatus of liquid food, which is another embodiment of the present invention. A conductive partition plate 36 is fixed in the heat pipe 30 so as to physically close the communication hole 31 continuing in a loop shape. When the inside of the communication hole 31 is filled with the heat-exposed food F, an electric closed loop circuit is constituted by the heat-exposed food F and the partition plate 36 due to the partition plate 36 having a conductive property, thereby allowing an induced current to flow to the heat-exposed food F.

The heat pipe 36 is provided with two exhaust portions 35a and 35b corresponding to both sides of the partition plate 36. The exhaust portion 35a has an exhaust hole 34a, which communicates with an inside hole 31a formed on one side of the partition plate 36. The exhaust portion 35b has an exhaust hole 34b, which communicates with an outside hole 31b formed on the other side of the partition plate 36. Thus, since the communication hole 30 is physically divided into two parts using the partition plate 36, each flow amount of heat-exposed foods F flowing into the inside hole 31a and the outside hole 31b can be easily regulated with the same quantity.

The current-carrying/heating apparatus shown in FIG. 2 is provided with the two exhaust portions 35a and 35b corresponding to both sides of the partition plat 36. However, it may be provided, as a structure in which the upper part and the lower part of the heat pipe 30 as shown in FIG. 2 are reversed, with two supply portions corresponding to both sides of the partition plate 36, or may be provided with two supply portions and two exhaust portions by disposing each partition plate 36 on and under the heat pipe 30.

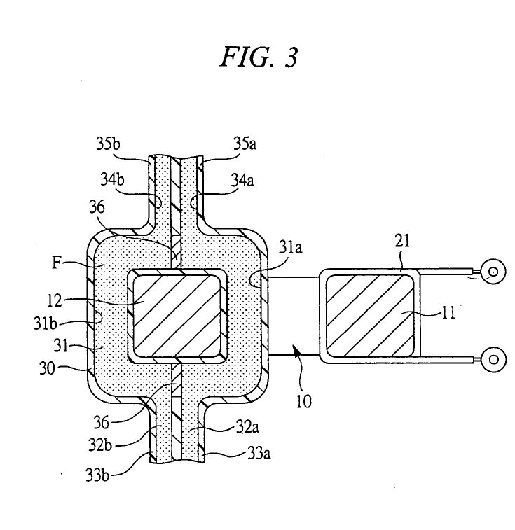

FIG. 3 is a sectional view showing the heat pipe 30 in the case where the above-mentioned two supply portions and two exhaust portions are provided, respectively. The two supply portions 33a and 33b are provided at the lower part of the heat pipe 30, and have supply holes 32a and 32b communicating with the inside hole 31a and the outside hole 31b, respectively. Further, two exhaust portions 35a and 35b are provided at the upper part of the heat pipe 30, and have exhaust holes 34a and 34b communicating with the inside hole 31a and the outside hole 31b, respectively. Thus, the communication hole 31 is physically divided into the inside hole 31a and the outside hole 31b by the two partition plates 36, and the flow velocity of the heat-exposed food F flowing into each hole is regulated. Further, an electric closed loop circuit is constituted by each conductive partition plate 36.

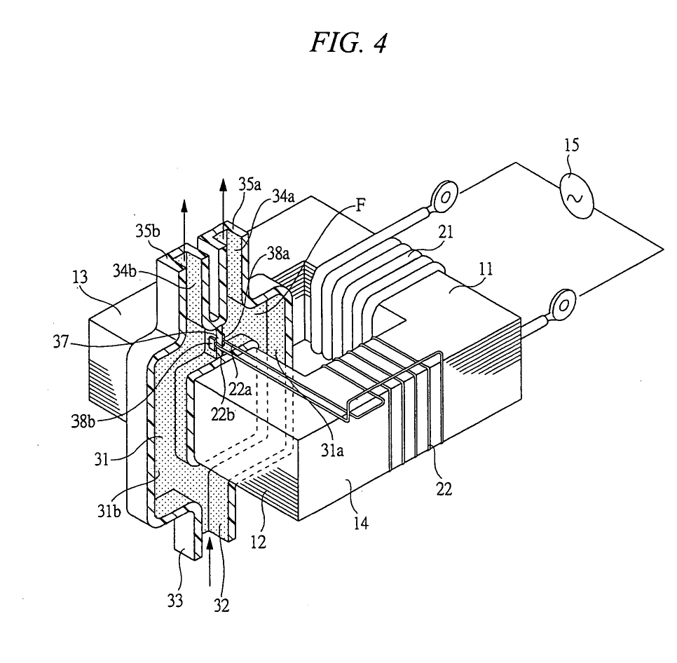

FIG. 4 is a partially broken perspective view showing a current-carrying/heating apparatus of liquid food, which is another embodiment of the present invention. An insulating partition plate 37 is provided in the heat pipe 34 to physically close the communication hole 31 continuing in a loop shape. Electrodes 38a and 38b are fixed to both surfaces of the partition plate 37. Both ends 22a and 22b of a secondary winding 22, winded about the iron-core leg 12 of the iron core 10, are connected to the electrodes 38a and 38b. The electrode 38a is exposed to the inside hole 31a partitioned by the partition plate 37. The electrode 38b is exposed to the outside hole 31b. When the inside of the communication hole 31 is filled with the heat-exposed food F, an electric closed loop circuit is constituted by the heat-exposed food F and the secondary winding 22 and an induced current flows to the heat-exposed food F.

Thus, the heat-exposed food F in the communication hole 31 constitutes the electric closed loop circuit through the secondary winding 22 and an induced voltage applied to the closed loop circuit is increased in proportion to the number of turns, i.e., the number of winding parts of the closed loop circuit, thereby allowing the induced voltage to be boosted. For example, if the winding number of the secondary winding 22 is four, a voltage five times higher than the voltage of the current-carrying/heating apparatus shown in FIG. 1 is induced in the closed loop circuit because that of the heat pipe 30 is one. Therefore, when the electric resistance of the heat-exposed food F is large, the current supplied to the heat-exposed food F is increased by boosting the induced voltage. Note that the winding number of the secondary winding 22 can be arbitrarily set in accordance with the electric resistance of the heat-exposed food F.

The heat pipe 30 shown in FIGS. 2 and 4 is a rectangular type tube of rectangular cross section, but may be a round type tube of circular cross section as shown in FIG. 1.

The current-carrying/heating apparatus shown in FIG. 4 may be also provided, as a structure in which the upper part and the lower part of the heat pipe 30 as shown in FIG. 4 are reversed, with two supply portions corresponding to both sides of the partition plate 37, or be provided with two supply portions and two exhaust portions by disposing each partition plate 37 on and under the heat pipe 30.

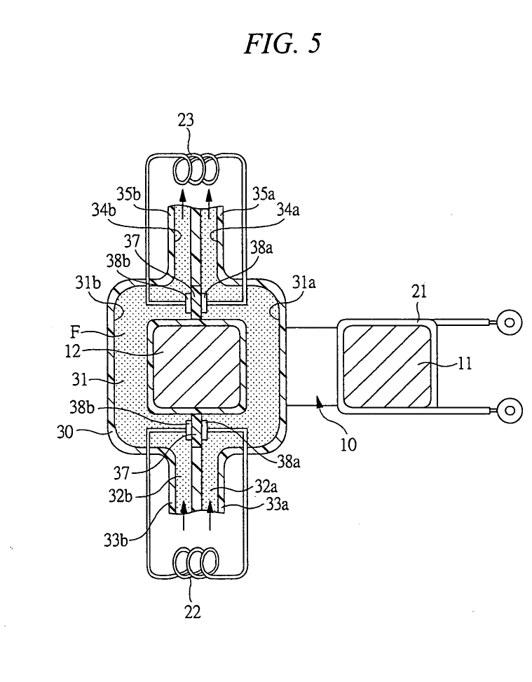

FIG. 5 is a sectional view showing the heat pipe 30 in the case where the above-mentioned two supply portions and two exhaust portions are provided. Two supply portions 33a and 33b are provided at the lower part of the heat pipe 30, and have supply holes 32a and 32b communicating with the inside hole 31a and the outside hole 31b, respectively. Further, two exhaust portions 35a and 35b are provided at the upper part of the heat pipe 30, and have exhaust holes 34a and 34b communicating with the inside hole 31a and the outside hole 31b, respectively. Electrodes 38a and 38b on a side of the supply portion are connected to the secondary winding 22 winded about the iron core 10, for example, about the iron-core leg 14. The electrodes 38a and 38b on a side of the exhaust portion are connected to the secondary winding 23 winded about the iron core 10, for example, about the iron-core leg 13.

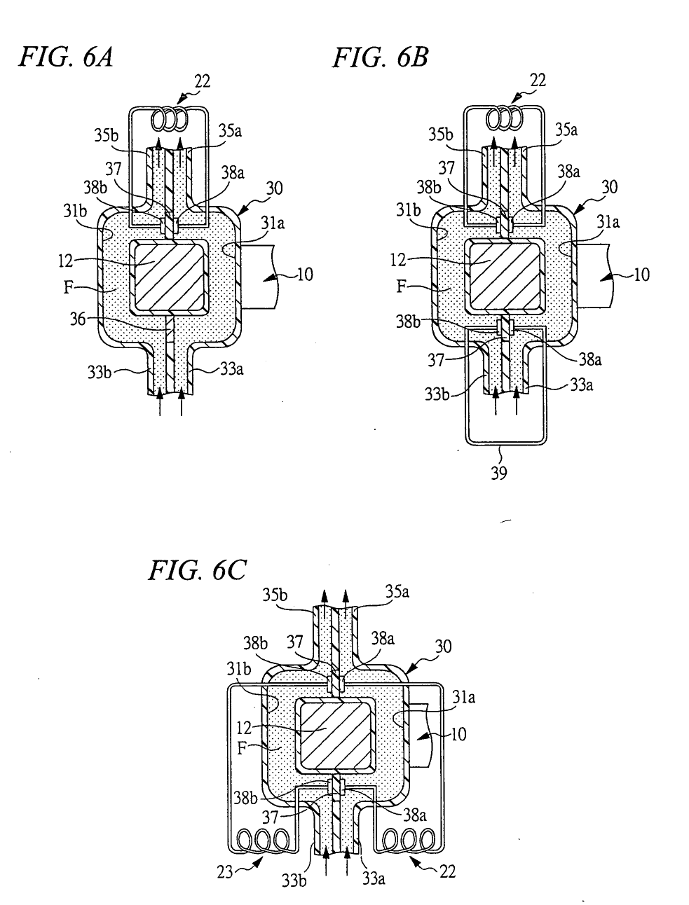

Each of FIGS. 6A to 6C is a sectional view partially showing a current-carrying/heating apparatus that is another embodiment of the present invention. The heat pipe 30 of each current-carrying/heating apparatus is provided with two supply portions and two exhaust portions. The heat-exposed food F, flowing into the heat pipe 30 from the supply portion 33a, is exhausted from the exhaust portion 35a through the inside hole 31a while the heat-exposed food F, flowing into the heat pipe 30 from the supply portion 33b, is exhausted from the exhaust portion 35b through the outside hole 31b.

In the current-carrying/heating apparatus shown in FIG. 6A, the supply portions 33a and 33b are partitioned by the conductive partition plate 36 while the exhaust portions 35a and 35b are partitioned by the insulating partition plate 37. The electrodes 38a and 38b, provided with both sides of the insulating partition plate 37, are connected to the secondary winding 22 winded about the iron core 10 similarly to the case shown in FIG. 4. In this case, the heat-exposed food F in the communication hole 31 constitutes an electric closed loop circuit through the secondary winding 22 and the conductive partition plate 36.

In the current-carrying/heating apparatus shown in FIG. 6B, both of the supply portions 33a and 33b and the exhaust portions 35a and 35b are partitioned by the insulating partition plates 37, respectively. The electrodes 38a and 38b, provided on both sides of the partition plate 37 near the exhaust portion, are connected to the secondary winding 22 winded about the iron core 10 similarly to the case shown in FIG. 4. In contrast, the electrodes 38a and 38b, provided with both sides of the partition plate 37 near the supply portion, are connected to each other through a short-circuit line 39. Therefore, in this case, the heat-exposed food F in the communication hole 31 constitutes an electric closed loop circuit through the secondary winding 22 and the short-circuit line 29.

In the current-carrying/heating apparatus shown in FIG. 6C, the secondary winding 22 are connected to the electrodes 38a and 38a, which are exposed to the inside of the inside hole 31a and provided on respective one sides of both insulating partition plates, while another secondary winding 23 are connected to the electrodes 38b and 38b, which are exposed to the outside hole 31b and provided on the respective other sides of both partition plates. Therefore, in this case, the heat-exposed food F in the communication hole 31 constitutes an electric closed loop circuit through the two secondary windings 22 and 23 parallel to each other.

In each current-carrying/heating apparatus shown in FIGS. 1 to 5, the heat pipe 30 winded about the iron core 10 has one turn, i.e., one winding part. As described above, the induced voltage, flowing to the communication hole 31 of the heat pipe 30, is boosted in proportion to the winding number of the electric closed loop circuit, thereby allowing the induced voltage to be set plural times higher when the heat pipe 30 itself has a plurality of winding parts in number.

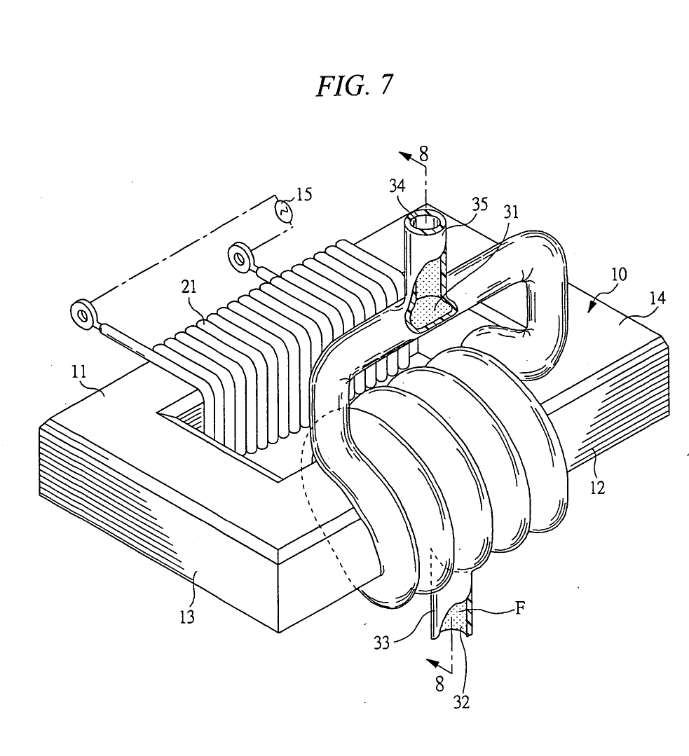

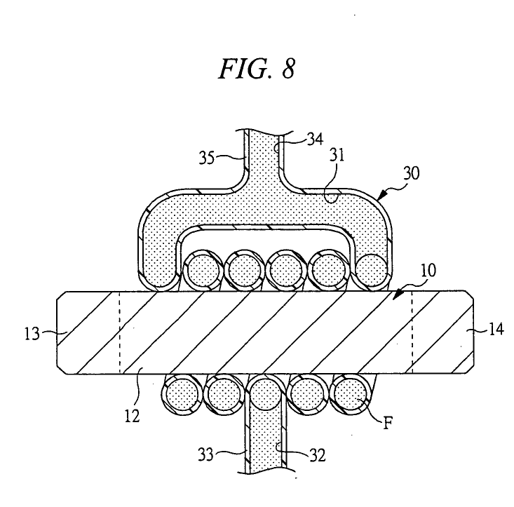

FIG. 7 is a partially broken perspective view showing a current-carrying/heating apparatus of liquid food, which is another embodiment of the present invention, and FIG. 8 is a sectional view taken along the 8-8 line in FIG. 7. The heat pipe 30 is winded five turns about the iron-core leg 12 and has five winding parts, thereby being winded helically. Both ends of the heat pipe 30 are linked to each other and the communication hole 31 in the heat pipe 30 continues in a loop shape. Therefore, when the heat-exposed food F is supplied into the communication hole 31, the electric closed loop circuit is constituted by the heat-exposed food F having been supplied.

To supply the heat-exposed food F into the communication hole 31, a supply portion 33 is provided at the center of the heat pipe 30 and a supply hole 32 in the supply portion 33 communicates with the communication hole 31. To exhaust the heat-exposed food F in the communication hole 31, an exhaust portion 35 is provided at a linking part of the heat pipe 30 and an exhaust hole 34 in the exhaust portion 35 communicates with the communication hole 31, whereby the heat-exposed food F, flowing into the communication hole 31 from the supply portion 33, is divided to flow toward the both ends of the heat pipe 30 and advance toward the exhaust portion 35. As shown in FIG. 7, the plurality of winding parts is formed by winding the heat pipe 30 about the iron core 10 plural turns, thereby allowing the induced voltage to be boosted in proportion to its turn numbers in comparison with the case of one turn as shown in FIG. 1.

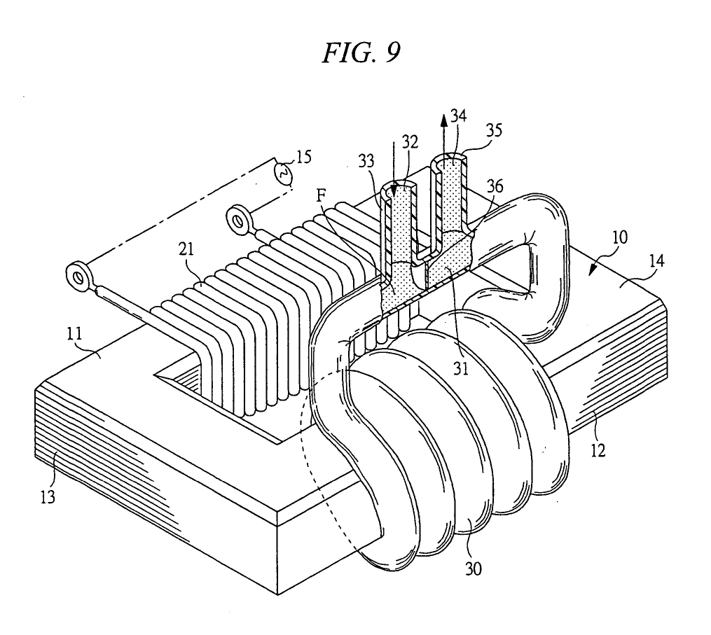

FIG. 9 is a partially broken perspective view showing a current-carrying/heating apparatus of liquid food, which is another embodiment of the present invention. In the current-carrying/heating apparatus, similarly to the current-carrying/heating apparatus shown in FIG. 7, the heat pipe 30 is winded five turns about the iron-core leg 12. A conductive partition plate 36 is provided in the heat pipe 30 so as to physically close the communication hole 31 continuing in a loop shape. A supply portion 33, corresponding to one side of the partition plate 36, is provided in the heat pipe 30 and an exhaust portion 35, corresponding to the other side, is provided, whereby the heat-exposed food F is prevented from directly flowing into the supply portion 33 and the exhaust portion 35 due to the partition plate 36. Therefore, when the inside of the communication hole 31 is filled with the heat-exposed food F, an electric closed loop circuit is constituted by the heat-exposed food F and the conductive partition plate 36, thereby allowing the induced current to flow to the heat-exposed food F.

The current-carrying/heating apparatus shown in FIG. 9 is provided with, unlike the case shown in FIG. 7, the supply portion 33 corresponding to one side of the partition plate 36 and the exhaust portion 37 corresponding to the other side. The helical communication hole 31 is divided into an upper-stream side part and a lower-stream side part by the partition plate 36.

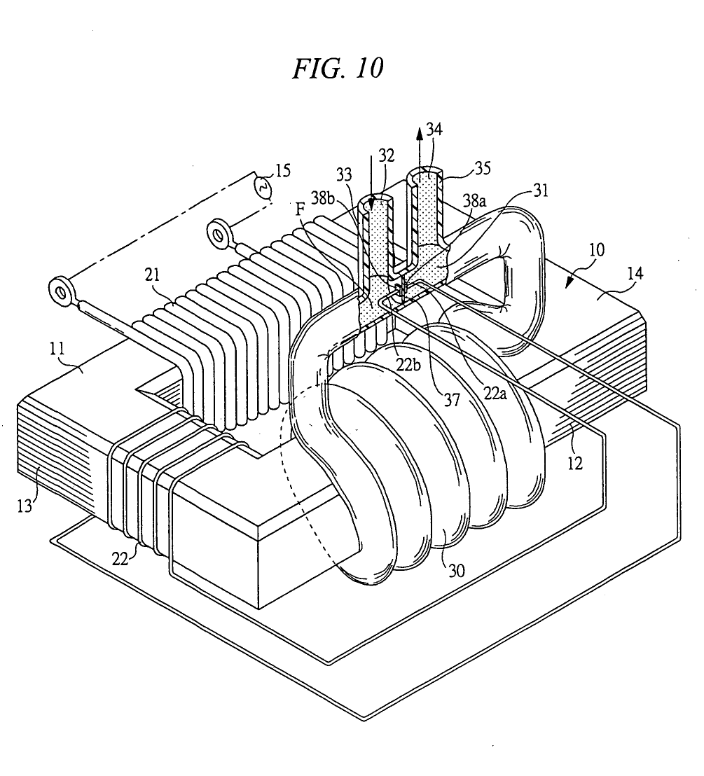

FIG. 10 is a partially broken perspective view showing a current-carrying/heating apparatus of liquid food, which is another embodiment of the present invention. In the current-carrying/heating apparatus, similarly to the current-carrying/heating apparatus shown in FIG. 7, the heat pipe 30 is winded five turns about the iron-core leg 12. An insulating partition plate 37 is provided in the heat pipe 30 so as to physically close the communication hole 31 continuing in a loop shape. The supply portion 33, corresponding to one side of the partition plate 37, is provided in the heat pipe 30 while the exhaust portion 35, corresponding to the other side, is provided therein, whereby the heat-exposed food F is prevented from directly flowing into the supply portion 33 and the exhaust portion 35 due to the partition plate 37.

The electrodes 38a and 38b are fixed to both surfaces of the partition plate 37. Both ends 22a and 22b of the secondary winding 22, winded about the iron-core leg 12 of the iron core 10, are connected to the electrodes 38a and 38b, respectively. The electrode 38a is exposed to the lower-stream side part partitioned by the partition plate 37 while the electrode 38b is exposed to the upper-stream side part. Therefore, when the inside of the communication hole 31 is filled with the heat-exposed food F, an electric closed loop circuit is constituted by the heat-exposed food F and the secondary winding 22 and the induced current flows to the heat-exposed food F.

In each heat pipe 30 shown in FIGS. 9 and 10, the supply portion 33 and the exhaust portion 35, corresponding to both sides of each of the partition plates 36 and 37, are provided. The heat-exposed food F flows into one side of the helical part of the heat pipe 30 from the other side and is heated. Note that the heat pipe 30 may be, as shown in FIG. 7, provided with the supply portion 33 at its center and further, as show in FIGS. 2 and 4, provided with two exhaust portions 35a and 35b corresponding to both sides of each of the partition plates 36 and 37.

The present invention is not limited to the above-mentioned embodiment, and can be variously altered and modified without departing from the gist thereof. For example, each turn number of the primary winding 21 and the secondary winding 22 is not limited to the turn number as shown in the drawings and may be set arbitrarily. Further, the current-carrying/heating apparatus may use, as the heat-exposed food, liquid meat and drink containing solid substances such as vegetables and/or pieces of meat, etc. in curry roux, and liquid medicaments, besides the above-mentioned liquid meat and drink such as juice or the like, and may heat them.

According to the present invention, a magnetic flux is generated around the iron core by the current applied to the primary winding. A current is induced through the heat-exposed food in the electric closed loop circuit by an operation of electromagnetic induction, which is performed by the magnetic flux. That is, the induced current directly flows to the heat-exposed food by the magnetic flux generated around the iron core and the heat-exposed food is heated, thereby allowing the heat-exposed food in the heat pipe to be heated uniformly and allowing the energy losses to be reduced and the heat-exposed food to be heated with high energy efficiency. Due to this, the heat-exposed food can be heated uniformly and with high energy efficiency in comparison with the case of providing the ring electrode to the transport pipe to carry a current to the heat-exposed food from the ring electrode.

What is claimed is:

1. A current-carrying/heating apparatus of liquid food, which carries a current to fluid heat-exposed food and heats the heat-exposed food by resistance heat obtained, the apparatus comprising:
a primary winding winded about an iron core and connected to an AC power supply; and
a heat pipe winded about said iron core, having a communication hole to which the heat-exposed food is supplied, and constituting an electric closed loop circuit through the heat-exposed food supplied to said communication hole,
wherein a magnetic flux is generated around said iron core by the current flowing to said primary winding, and a current, induced by an operation of electromagnetic induction of the magnetic flux, flows to the heat-exposed food.

2. A current-carrying/heating apparatus of liquid food, which carries a current to fluid heat-exposed food and heats the heat-exposed food by resistance heat obtained, the apparatus comprising:
a primary winding winded about an iron core and connected to an AC power supply;
a heat pipe winded about said iron core and having a communication hole to which the heat-exposed food is supplied; and
a conductive partition member provided in said heat pipe, physically closing said communication hole, and constituting an electric closed loop circuit along with the heat-exposed food supplied into said communication hole,
wherein a magnetic flux is generated around said iron core by the current flowing to said primary winding, and a current, induced by an operation of electromagnetic induction of the magnetic flux, flows to the heat-exposed food through said partition member.

3. A current-carrying/heating apparatus of liquid food, which carries a current to fluid heat-exposed food and heats the heat-exposed food by resistance heat obtained, the apparatus comprising:
a primary winding winded about an iron core and connected to an AC power supply;
a heat pipe winded about said iron core and having a communication hole to which the heat-exposed food is supplied;
an insulating partition member provided in said heat pipe and physically closing said communication hole; and
a secondary winding winded about said iron core, having a terminal provided so as to be exposed to said communication hole on both sides of said partition member, and constituting an electric closed loop circuit along with the heat-exposed food supplied into said communication hole,
wherein a magnetic flux is generated around said iron core by the current flowing to said primary winding, and a current, induced by an operation of electromagnetic induction of the magnetic flux, flows to the heat-exposed food through said secondary winding.

4. The apparatus according to claim 1, wherein said heat pipe includes: a supply portion in which a supply hole communicating with said communication hole is provided and which supplies the heat-exposed food into said communication hole; and an exhaust portion in which an exhaust hole communicating with said communication hole is provided and which exhausts the heat-exposed food from said communication hole, and
the heat-exposed food is heated while continuously flowing into said communication hole.

5. The apparatus according to claim 2, wherein said heat pipe includes: a supply portion in which a supply hole communicating with said communication hole is provided and which supplies the heat-exposed food into said communication hole; and an exhaust portion in which an exhaust hole communicating with said communication hole is provided and which exhausts the heat-exposed food from said communication hole, and
the heat-exposed food is heated while continuously flowing into said communication hole.

6. The apparatus according to claim 3, wherein said heat pipe includes: a supply portion in which a supply hole communicating with said communication hole is provided and which supplies the heat-exposed food into said communication hole; and an exhaust portion in which an exhaust hole communicating with said communication hole is provided and which exhausts the heat-exposed food from said communication hole, and
the heat-exposed food is heated while continuously flowing into said communication hole.

7. The apparatus according to claim 1, wherein said heat pipe includes a plurality of winding parts, which are winded about said iron core and continue helically.

8. The apparatus according to claim 2, wherein said heat pipe includes a plurality of winding parts, which are winded about said iron core and continue helically.

9. The apparatus according to claim 3, wherein said heat pipe includes a plurality of winding parts, which are winded about said iron core and continue helically.

10. The apparatus according to claim 4, wherein said heat pipe includes a plurality of winding parts, which are winded about said iron core and continue helically.

11. The apparatus according to claim 5, wherein said heat pipe includes a plurality of winding parts, which are winded about said iron core and continue helically.

12. The apparatus according to claim 6, wherein said heat pipe includes a plurality of winding parts, which are winded about said iron core and continue helically.
